(19) United States
(12) Patent Application Publication
(10) Pub. No.: US 2004/0268139 A1
(43) Pub. Date: Dec. 30, 2004

(54) Systems and methods for declarative client input security screening

(75) Inventors: Brian S. Christian, Sammamish, WA (US); Russell M. Eames, Redmond, WA (US); Thomas Fakes, Redmond, WA (US); Bhavesh R. Thaker, Redmond, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMON, WA (US)

(21) Appl. No.: 10/606,089

(22) Filed: Jun. 25, 2003

(51) Int. Cl. H04L 9/00; H04L 9/32; G06F 11/30; G06F 12/14

(52) U.S. Cl. 713/200

(57) ABSTRACT

Systems and methods are described for declarative client input security screening. A configuration module in a web-based application (or project) that includes one or more web pages is designed to allow client input to be screened for the web pages by declaring particular screening attributes and actions therein. A global section in such a configuration module includes security screens that apply to input of all types, while other individual sections include security screens that apply only to input of particular type. The global section provides a way to consolidate screening that applies to all client input types, thereby precluding redundant screens having to be maintained in each individual section. Client input that survives the security screening is cached and used in normal page processing. By including the security screens in a declarative section, maintenance is made more efficient and reliable.

### TECHNICAL FIELD

The systems and methods described herein relate to providing security for web services. More particularly, the systems and methods described herein relate to declarative client input security screening for web services.

### BACKGROUND

Because of the number and kinds of hacker attacks on servers and on clients utilizing servers, server and client computer security has become a top priority for web based service providers. If service providers cannot provide web services which client users regard as providing safe content, i.e., content that does not contain code that can be harmful to the users' computers, then client use of the web services will diminish rapidly.

Some web server-based applications allow user to affect text that is displayed in other users' browsers. One example of such an application is a media player application that exposes artist and album information in the application itself. The exposed data can be manipulated by the application before being displayed on multiple users' browsers.

Another example of an application that can be subject to hack attacks is a web-based search application. A client browser initiates a search and a search engine collects content from various web sites that meet the search criteria. The search application then displays the content on a computer hosting the client browser. If malicious content is delivered to the client browser, then serious problems may arise in the client computer.

In short, any web site that allows client input to be re-displayed is a target for various forms of security attacks. Additionally, security attacks are not limited to schemes that attack sites in such a way as to allow client input to be re-displayed. Attacks to create buffer overruns, to disrupt a server, to gain particular knowledge of the internal structure of a site, etc. may also be used to hack security.

A typical method to combat security attacks using client input is to pre-filter all user input, discarding or altering any potentially dangerous strings of text, such as a <script> tag. While this can be created either in a shared code component or directly in individual projects, there has historically been no way to enforce this form of validation. As a result, web pages that do not conform to the filtering technique expose security flaws in a system.

Therefore, improvements to existing computer security techniques that efficiently enforce client input security screening would be advantageous over existing techniques.

### SUMMARY

Systems and methods are described for declarative client input security screening. The techniques described herein are “declarative” in that the functional aspects of the techniques are performed outside individual page code. As a result, the security screening can be performed for one or more web pages in a single declarative location, thereby making maintenance, review and updates more efficient, reliable and manageable.

A configuration module in a web-based application (or project) that includes one or more web pages is designed to allow client input to be screened for the web pages by declaring particular screening attributes and actions therein. A global section in such a configuration module includes security screens that apply to input of all types, while other individual sections include security screens that apply only to input of particular type. The global section provides a way to consolidate screening that applies to all client input types, thereby precluding redundant screens having to be maintained in each individual section.

Client input that survives the security screening is cached and used in normal page processing.

### BRIEF DESCRIPTION OF THE DRAWINGS

The same numbers are used throughout the document to reference like components and/or features.

FIG. 1 illustrates an exemplary network environment.

FIG. 2 illustrates an exemplary server device.

FIG. 3 is a flowchart illustrating a methodological implementation of declarative client input security screening for web-based services.

FIG. 4 illustrates a general computer environment, which can be used to implement the techniques described herein.

### DETAILED DESCRIPTION

The following depictions describe one or more exemplary systems and/or methods for declarative client input security screening for web services. The examples described are but a few examples of various manners in which the subject matter of the appended claims may be implemented. The described examples are not intended to limit the scope of the appended claims in any manner, but are shown to accurately describe the best mode of carrying out the invention delineated by the claims.

The examples relate to ASP.NET technology, but may be implemented in one or more other types of web services framework. ASP.NET (Active Server Pages) is a server-side scripting technique promulgated by MICROSOFT CORP® that enables server execution of scripts embedded in web pages. ASP.NET is included in the WINDOWS® family of operating systems.

An ASP.NET file (a file having an .aspx extension) may contain HTML, text, XML and/or one or more scripts. Scripts in the ASP.NET file are executed by a server. When a client web browser requests an HTML file from a server, the server merely returns the requested HTML file. When a client web browser requests an ASP.NET file from a server, an Internet Information Server (IIS) in the server passes the request to an ASP.NET module. An ASP.NET engine then compiles the requested file into a temporary Assembly, which is executed on the server. The resultant output of this execution is then returned to the client web browser, usually as a plain HTML file.

Although the present examples will focus on ASP.NET technology, it is noted that the examples may be implemented with any other form of web services scripting technology without departing from the scope of the claimed systems and methods.

The systems and methods described herein relate to a web page development framework within which page developers can only retrieve pre-screened client (user) input. For convenience, the same syntax that is used in the web development environment is also used in the security screening. The described techniques are designed to prevent page developers utilizing the described systems and methods to inadvertently use unsafe data (i.e. unfiltered client input).

Because the validation needs of user input varies greatly from project to project, or even value to value, the techniques described herein allow for per-value, per-project configuration for client input security screening. The screening configuration is completely declarative in that it does not require any special code, programming, function calls, etc. to be present within individual web pages.

As a project is created, acceptable items of client input and associated required filters are ascertained. For each item of input, there is a corresponding entry into a custom section of the file designated “web.config.” This file contains general configuration information for the entire project.

An exemplary portion of a web.config file is shown below. The following example will be referred to throughout the remainder of this document.

```
<inputValidation filter=”[\&lt;\&gt;]” action=”remove”>
  <queryString name=”srch” filter=”[%\;
  ( ) { }!\n\t]” action=”remove”/>
  <serverVariable name]”SERVER_NAME” filter=”[\w|.]+” />
</inputValidation>
```

The example shown above will be discussed in greater detail, below, after more system and method details are described.

Exemplary Network Environment

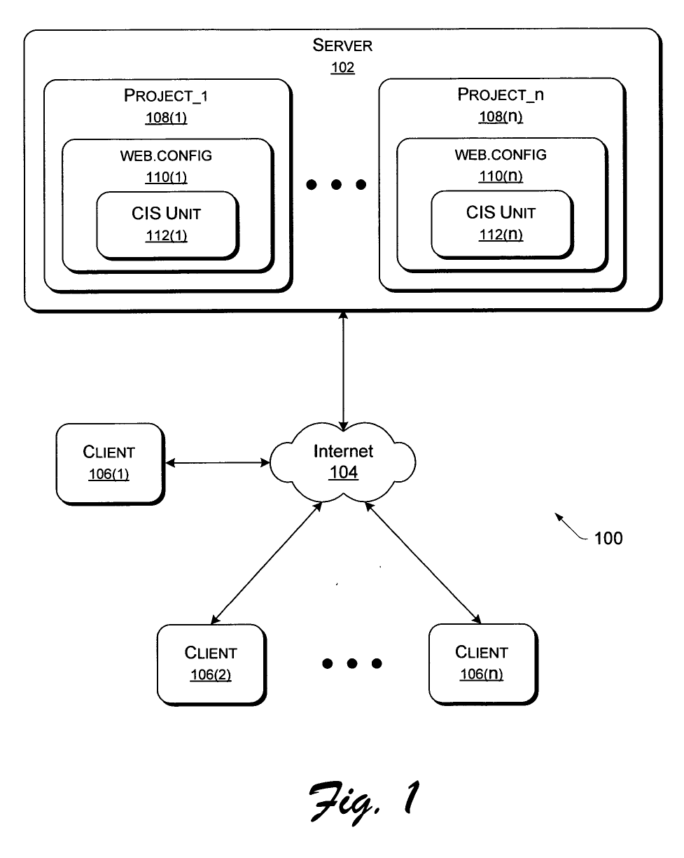

FIG. 1 illustrates an exemplary network environment 100. The exemplary network environment 100 includes a server 102 that communicates over the Internet 104 to provide web content to multiple clients 106(1)-106(n), hereinafter referred to collectively as client(s) 106.

Although the server 102 is shown communicating with the clients 106 over the Internet 104, it is noted that the server 102 may access the clients 106 via some other type of network, such as a local area network (LAN), a wide access network (WAN), or the like. In addition, a server 102 may sometimes communicate directly with a client 106 via a direct connection via a modem, cable modem, etc.

The server 102 also includes multiple projects 108(1)-108(n), also referred to herein as web applications or web services and designated collectively as project 108 when appropriate. In the present example, the projects 108 are significantly generalized and may contain virtually any number of content pages or items (not shown).

Each project 108 includes a web.config file 110 that includes general configuration statements related to a specific project 108. Web.config file 110(1) may be identical to or different from web.config file 110(n), depending on the particular needs of each project 108. To function appropriately within the server 102, the web.config file 110 must be included in each project 108.

Each web.config file 110 includes a client input security screening (CISS) unit 112. The CISS unit 112 may be a separate module within the web.config file 110, but will typically comprise a contiguous section of statements within the statements included in the web.config file 110. Particular elements and functions of the CISS unit 112 will be discussed in greater detail, below.

Exemplary Client Input Security Screening Unit

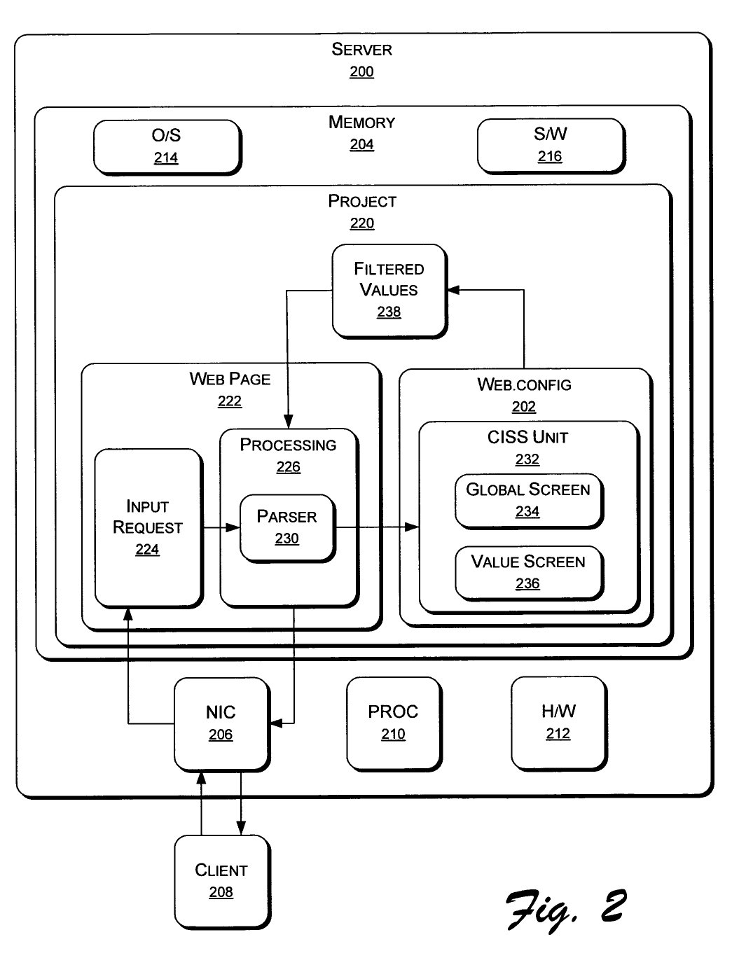

FIG. 2 is a simplified block diagram depicting an exemplary server 200 that includes an exemplary web.config file 202 similar to the web.config files 110 shown in FIG. 1. The server 200 also includes memory 204, and a network interface card 206 configured to communicate with a client 208 over a network (not shown). In other implementations, the network interface card 206 may be replaced with a modem (not shown) or some other type of communication device suitable for providing content communications between the server 200 and the client 208. A processor 210 and other miscellaneous hardware 212 typically found in server configurations are also included in the server 200. Although only one processor 210 is shown in the present example, it is noted that two or more processors may be used in other implementations of the techniques described herein.

An operating system 214 is stored in the memory 204 and controls general operation of the server 200 and its components. Also, the memory 204 stores miscellaneous software programs 216—such as applications—that may be required to provide functional operability to the server 200.

A project 220 is shown stored in the memory 204 and includes a web page 222. It is noted that any practicable number of web pages may be included in the project 220, however, only one is shown in the present example for convenience. The web page 222 includes an input request 224 (though more may also be included) and a processing module 226, which represents the web page 222 being served to the client 208. It is noted that the processing module 226 is not necessarily a single entity, but represents page processing other than the input request.

The web.config file 202 contains the settings to configure a parser 230 to parse values received from the client 208 in response to the input request 224 and a client input security screening (CISS) unit 232. The CISS unit 232 includes a global screening portion 234 that is configured for all types of input values received from the client 208. Although not required, the global screening portion 234 of the CISS unit 232 may be pre-defined for all web.config files (i.e. all projects) in the server 200. Providing a pre-defined global screening portion 234 in the web.config file 202 ensures that page developers may not override certain system-wide security screening features. Additionally, a single web.config file may be provided for more than one project to serve as a global security screening function.

The CISS unit 232 also includes a values screening portion 236 that is configured to screen individual types of values that may be received from the client 208 (e.g., URL parameters, header values, form values, cookies). Although the global screening portion 234 may be configured to screen certain values from all types of client input, the values screening portion 236 may screen certain values from only one (or more than one, but not all) type of input value by including individual value screens, one for each particular type of input value. In other words, each such individual value screen only screens a single form of input, but multiple individual value screens may be included to cover all types of expected input.

The memory 204 also stores filtered values 238 that survive the security screening effected by the CISS unit 232. The filtered values 238 shown in the present example represent any reference herein to a cache, or to cached values.

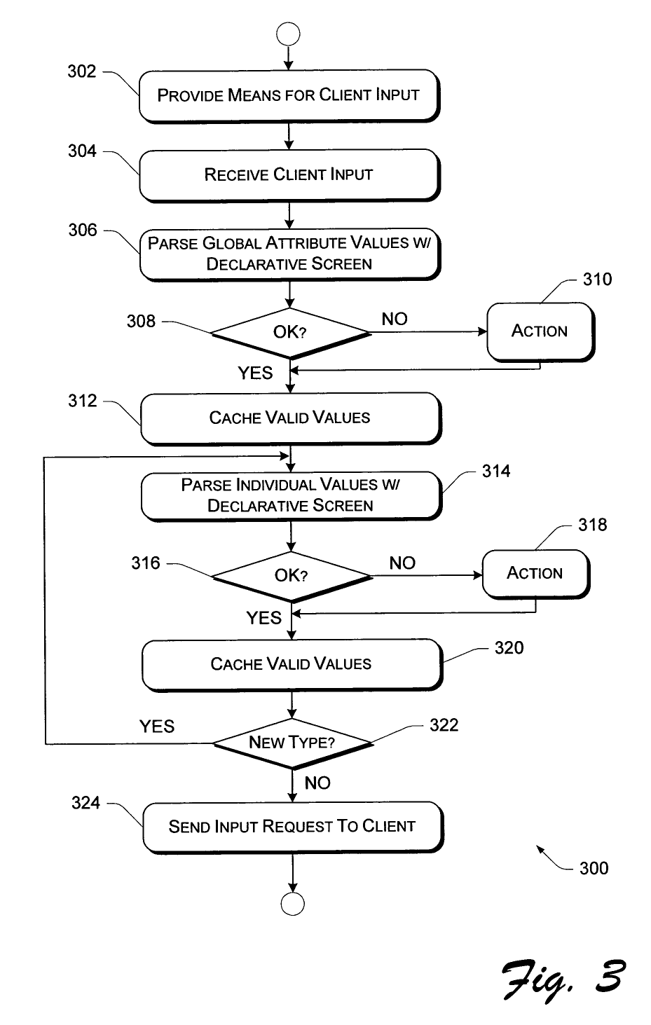

The functions of the elements depicted in FIG. 2 will be discussed in greater detail, below, with respect to the flow diagram depicted in FIG. 3.

Exemplary Methodological Implementation

FIG. 3 is a flowchart 300 illustrating a methodological implementation of declarative client input security screening for web-based services. In the following discussion, continuing reference will be made to the elements and reference numerals shown in FIG. 2.

At block 302, the server 200 provides a means for client input, such as providing a block for the client to enter, say, a user name. Any input provided via this means is received at block 304. At block 306, the parser 230 parses the input data received by the server. The particular form of valid data that results from at least partially invalid input depends on what values are being screened in the global screening portion 234 of the client input security screening unit 232. As previously stated, the global screening portion 234 screen all types of input values: URL parameters, header values, form values and cookies. Therefore, any screened values will be screened from all these types of values in the global screening portion 234.

In the example begun above, the global screening portion 234 is represented by: <inputValidation filter=“[\&It;&gt;]” action=“remove”>.

This screening will be performed on all types of client input to the server and will remove all “<” and “>” symbols, regardless of other screening that may be performed on individual types of values. In another implementation, if both symbols are present in the input string, the symbols and all text in between will be removed because these symbols do not usually denote valid input. However, if one of these characters is received, it is probably a simple typographical error and it will be safe to simply remove the character.

If one or more invalid characters is contained in the client input (“No” branch, block 308), then the designated action (“remove” in the example above) is performed at block 310. Valid client input values are cached at block 312 where they can be recalled for subsequent processing.

After the global screening has been performed on an input type, individual types of client input are parsed at block 314. In other words, when an input value of a certain type has passed the global security screening, the input value may be subjected to additional screening set up for that certain type of input value. One or more security screens may be applied to one or more value types and/or security screening for one or more value types may not be present.

In the original example, value types of queryString and serverVariable are screened after the global screening. The individual values section describes the entire range of available input to the application to which it corresponds. Other value types that may be screened in this section are header values, form values, server values and cookies, because each of these input types may be manipulated to attempt malicious activity.

<queryString name=“srch” filter=“[%\;( ) {}!\n\t]” action=“remove”/>

<serverVariable name=“SERVER_NAME” filter=“[\w|·]+”/>

In this example, only the query string parameter named “srch” and the server variable named “SERVER_NAME” are available as external input to a page developer. Then, if the developer tried to access a query string variable named “srch2” the developer would receive an empty string even if “srch2” exists in the query string collection. This is significant in that it forces anybody configuring the service to consider any possible user input and apply some form of filter on it to access it.

The queryString screen shown above allows the “srch” parameter, but will remove any instances of the bracketed items (i.e. %\;( ){}!\n\t). In at least one implementation, the default behavior (if the optional “action=‘remove’” parameter and value are not present) is to disallow the entire string if one of the screened characters is detected. In such an implementation, with respect to the serverVariable screen shown above, the screen would return an empty string to a page's code if the server name were to contain any whitespace.

However, the presence of the “action=‘remove’” parameter and value in the queryString screen shown above, only the screened characters will be removed from a string before the string is passed back to the page code. For example, if the query string being screened was “srch=my % search<” then the string returned to the page code would be “my search”. The “%” character would be removed in the queryString screen, and the “<” character would be removed in the global screening section.

If an invalid character is detected (“No” branch, block 316), then a default action is taken on the character or string at block 318. Values that survive the screening (“Yes” branch, block 316) are cached at block 320. If there are other value types to parse (“Yes” branch, block 322), then the processing reverts to block 314 and repeats. If all value types have been screened (“No” branch, block 322), then the page processing continues at block 324.

It is again noted that the discussion above only describes a few examples of a vast number of client input security screens that may be implemented using the techniques described herein. It is also noted that the syntax used in the examples is not absolute, but that one or more other types of syntax may be utilized to carry out the techniques in certain environments.

The techniques force pages developed within a system to conform to certain security standards and to have all possible inputs considered in developing the page. In addition, this security feature is implemented in a declarative manner that makes it more efficient and more reliable to maintain when compared with other techniques. A page developer or maintainer, instead of having to check each individual line of code for security purposes, need only review the web.config file to confirm the presence of desired security screens (or to detect the lack thereof).

Exemplary Operating Environment

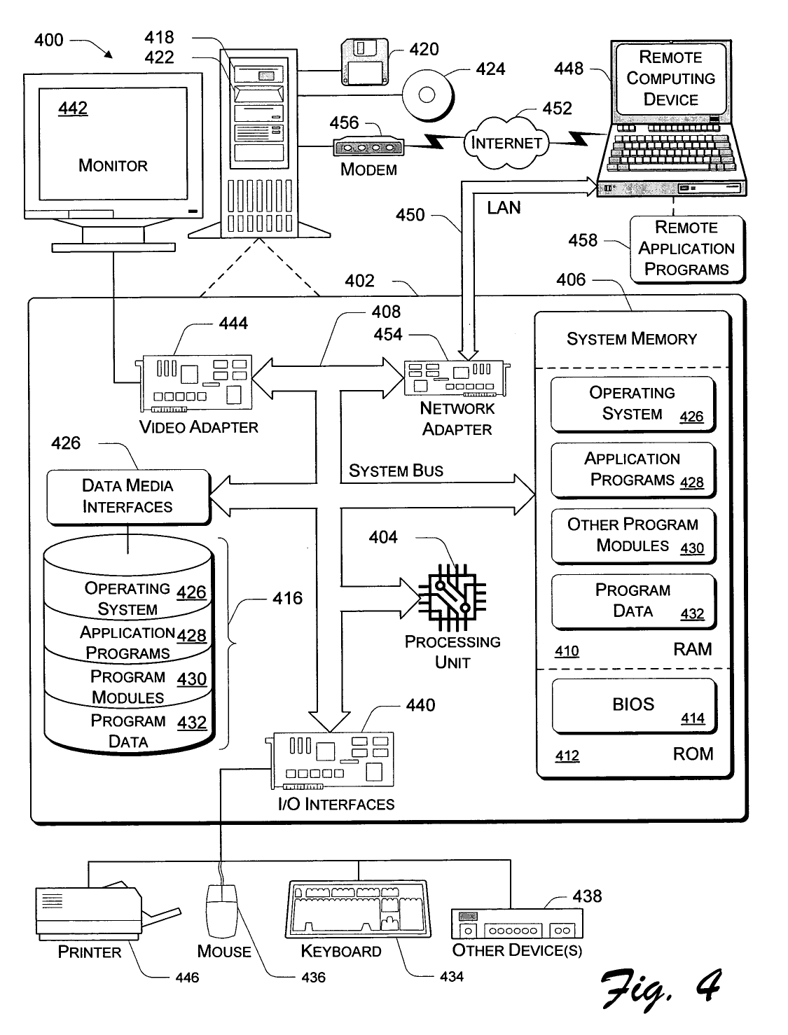

FIG. 4 illustrates a general computer environment 400, which can be used to implement the techniques described herein. The computer environment 400 is only one example of a computing environment and is not intended to suggest any limitation as to the scope of use or functionality of the computer and network architectures. Neither should the computer environment 400 be interpreted as having any dependency or requirement relating to any one or combination of components illustrated in the exemplary computer environment 400.

Computer environment 400 includes a general-purpose computing device in the form of a computer 402. Computer 402 can be, for example, a client 110 or server 102 of FIG. 1. The components of computer 402 can include, but are not limited to, one or more processors or processing units 404, a system memory 406, and a system bus 408 that couples various system components including the processor 404 to the system memory 406.

The system bus 408 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 402 typically includes a variety of computer readable media. Such media can be any available media that is accessible by computer 402 and includes both volatile and non-volatile media, removable and non-removable media.

The system memory 406 includes computer readable media in the form of volatile memory, such as random access memory (RAM) 410, and/or non-volatile memory, such as read only memory (ROM) 412. A basic input/output system (BIOS) 414, containing the basic routines that help to transfer information between elements within computer 402, such as during start-up, is stored in ROM 412. RAM 410 typically contains data and/or program modules that are immediately accessible to and/or presently operated on by the processing unit 404.

Computer 402 may also include other removable/non-removable, volatile/non-volatile computer storage media. By way of example, FIG. 4 illustrates a hard disk drive 416 for reading from and writing to a non-removable, non-volatile magnetic media (not shown), a magnetic disk drive 418 for reading from and writing to a removable, non-volatile magnetic disk 420 (e.g., a “floppy disk”), and an optical disk drive 422 for reading from and/or writing to a removable, non-volatile optical disk 424 such as a CD-ROM, DVD-ROM, or other optical media. The hard disk drive 416, magnetic disk drive 418, and optical disk drive 422 are each connected to the system bus 408 by one or more data media interfaces 426. Alternatively, the hard disk drive 416, magnetic disk drive 418, and optical disk drive 422 can be connected to the system bus 408 by one or more interfaces (not shown).

The disk drives and their associated computer-readable media provide non-volatile storage of computer readable instructions, data structures, program modules, and other data for computer 402. Although the example illustrates a hard disk 416, a removable magnetic disk 420, and a removable optical disk 424, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 416, magnetic disk 420, optical disk 424, ROM 412, and/or RAM 410, including by way of example, an operating system 426, one or more application programs 428, other program modules 430, and program data 432. Each of such operating system 426, one or more application programs 428, other program modules 430, and program data 432 (or some combination thereof) may implement all or part of the resident components that support the distributed file system.

A user can enter commands and information into computer 402 via input devices such as a keyboard 434 and a pointing device 436 (e.g., a “mouse”). Other input devices 438 (not shown specifically) may include a microphone, joystick, game pad, satellite dish, serial port, scanner, and/or the like. These and other input devices are connected to the processing unit 404 via input/output interfaces 440 that are coupled to the system bus 408, but may be connected by other interface and bus structures, such as a parallel port, game port, or a universal serial bus (USB).

A monitor 442 or other type of display device can also be connected to the system bus 408 via an interface, such as a video adapter 444. In addition to the monitor 442, other output peripheral devices can include components such as speakers (not shown) and a printer 446 which can be connected to computer 402 via the input/output interfaces 440.

Computer 402 can operate in a networked environment using logical connections to one or more remote computers, such as a remote computing device 448. By way of example, the remote computing device 448 can be a personal computer, portable computer, a server, a router, a network computer, a peer device or other common network node, and the like. The remote computing device 448 is illustrated as a portable computer that can include many or all of the elements and features described herein relative to computer 402.

Logical connections between computer 402 and the remote computer 448 are depicted as a local area network (LAN) 450 and a general wide area network (WAN) 452. Such networking environments are commonplace in offices, enterprise-wide computer networks, intranets, and the Internet.

When implemented in a LAN networking environment, the computer 402 is connected to a local network 450 via a network interface or adapter 454. When implemented in a WAN networking environment, the computer 402 typically includes a modem 456 or other means for establishing communications over the wide network 452. The modem 456, which can be internal or external to computer 402, can be connected to the system bus 408 via the input/output interfaces 440 or other appropriate mechanisms. It is to be appreciated that the illustrated network connections are exemplary and that other means of establishing communication link(s) between the computers 402 and 448 can be employed.

In a networked environment, such as that illustrated with computing environment 400, program modules depicted relative to the computer 402, or portions thereof, may be stored in a remote memory storage device. By way of example, remote application programs 458 reside on a memory device of remote computer 448. For purposes of illustration, application programs and other executable program components such as the operating system are illustrated herein as discrete blocks, although it is recognized that such programs and components reside at various times in different storage components of the computing device 402, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program 11 modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method, comprising:
receiving data input through a web page from a client device;
referencing a declarative module to determine a client input security screen to apply to the data input from the client device; and
applying the client input security screen to the data input from the client device.

2. The method as recited in claim 1, wherein the declaration module further comprises a global section that includes at least one client input security screen that applies to any type of client input value.

3. The method as recited in claim 1, wherein the declaration module further comprises an individual values section that includes at least one client input security screen that applies to a particular type of client input value.

4. The method as recited in claim 3, wherein the particular type of client input value is one of the following types of client input values: query string; server variable; form value; cookie.

5. The method as recited in claim 1, wherein the declaration module further comprises a web.config file.

6. The method as recited in claim 1, wherein the applying the client input security screen further comprises executing a default action on invalid client input detected by the client input security screen.

7. The method as recited in claim 1, wherein the applying the client input security screen further comprises executing a specified action on invalid client input detected by the client input security screen, the specified action being specified in the client input security screen.

8. The method as recited in claim 1, wherein a client input security screen further comprises one or more values that may be entered as client input, the one or more values further comprising the only values that may be entered as client input.

9. The method as recited in claim 1, wherein a client input security screen further comprises one or more screened values that, when detected in the client input, cause an action to be taken on the client input.

10. The method as recited in claim 9, wherein the action to be taken further comprises removing the one or more screened values detected in the client input.

11. The method as recited in claim 9, wherein the action to be taken further comprises removing an entire string that contains the one or more screened values detected in the client input.

12. A system, comprising:
a web page server unit configured to provide one or more web pages to one or more client devices over a distributed network;
means for receiving client input data;
a declaration module configured to include at least one client input security screen that declares one or more screening rules for client input; and
a client input security screening unit configured to apply the one or more screening rules for client input to the client input data and to perform one or more actions on invalid client input data.

13. The system as recited in claim 12, wherein the declaration module further comprises a global section that includes one or more client input security screens that are applied to all types of client input.

14. The system as recited in claim 12, wherein the declaration module further comprises an individual values section that includes one or more client input security screens that are applied to specified types of client input.

15. The system as recited in claim 12, wherein the declaration module further comprises a global section that includes one or more client input security screens that are applied to all types of client input, and an individual values section that includes one or more client input security screens that are applied to specified types of client input.

16. The system as recited in claim 12, wherein a screening rule further comprises a client input variable that may be accepted as input from a client.

17. The system as recited in claim 12, wherein a screening rule further comprises one or more screened characters that, when detected in client input, are screened from the client input according to a screening rule.

18. The system as recited in claim 17, wherein the screening rule further comprises a default screening action that is applied in the absence of a specified screening action.

19. The system as recited in claim 17, wherein the screening rule further comprises a specified screening action that is applied to the screened client input.

20. The system as recited in claim 12, wherein the declaration module further comprises a web.config file.

21. One or more computer-readable media containing computer-executable instructions that, when executed on a computer, perform the following steps:
serving a web page to a client over a distributed network;
receiving client input via the web page;
comparing the client input with one or more client input security screens stored in a security declaration module;
if invalid client input is detected, performing a screening action on the invalid client input as indicated by the security declaration module; and
wherein the one or more input security screens included in the security declaration module can be applied to multiple web pages.

22. The one or more computer-readable media as recited in claim 21, wherein the one or more client input security screens further comprise a global section configured to screen all types of client input values.

23. The one or more computer-readable media as recited in claim 21, wherein the one or more client input security screens further comprise an individual values section configured to screen particular types of client input values.

24. The one or more computer-readable media as recited in claim 21, wherein the security declaration module further comprises a web.config file.

25. The one or more computer-readable media as recited in claim 21, wherein the screening action further comprises an action specified in a client input security screen.

26. The one or more computer-readable media as recited in claim 21, wherein the screening action further comprises a default action that is not required to be specified in a client input security screen.

27. The one or more computer-readable media as recited in claim 21, wherein the multiple web pages are included in a web project.

28. The one or more computer-readable media as recited in claim 21, wherein the multiple web pages are included in a web-based application.
